(19) United States
(12) Patent Application Publication
(10) Pub. No.: US 2023/0082280 A1
(43) Pub. Date: Mar. 16, 2023

(54) METHODS FOR BROADCASTING, RECEIVING AND ANALYSING A DATA STREAM BROADCAST IN AT LEAST ONE BROADCAST NETWORK, AND CORRESPONDING DEVICES AND COMPUTER PROGRAM

(71) Applicants: ENENSYS TECHNOLOGIES, CESSON-SEVIGNE (FR); TDF, MONTROUGE (FR)

(72) Inventor: David Vincent, AMANLIS (FR)

(21) Appl. No.: 17/796,314

(22) PCT Filed: Jan. 29, 2021
(86) PCT No.: PCT/EP2021/052104

§ 371 Date: Jul. 29, 2022

(30) Foreign Application Priority Data
Jan. 31, 2020 (FR) 2001007

(51) Int. Cl. H04N 21/658; H04N 21/258

(52) U.S. Cl. CPC H04N 21/6581; H04N 21/25841

(57) ABSTRACT

A method for broadcasting a data stream in at least one broadcast network. The method includes inserting, into the data stream, at least one identifier associated with at least one broadcast area of the broadcast network used to broadcast the data stream. The at least one identifier is transmitted in signalling information of an application to be executed by at least one receiver of the data stream.

### 1. FIELD OF THE INVENTION

The field of the invention is that of broadcasting information, in particular television services, in one or more broadcast networks.

More specifically, the invention proposes a solution for identifying at least one broadcast area associated with a broadcast network used to broadcast a data stream. The invention thus allows, in particular, to measure the audience of a television programme per broadcast area.

The invention applies in particular, but not exclusively, to the broadcasting of data streams according to ATSC, in particular ATSC 3.0 (“Advanced Television Systems Committee”), DVB-T or DVB-T2 (“Digital Video Broadcasting-Terrestrial), DVB-S or DVB-S2 (“Digital Video Broadcasting-Satellite”), or else DVB-C (“Digital Video Broadcasting—Cable”) standard.

### 2. PRIOR ART

Today there are solutions that allow to benefit from interactive services with the programmes of the television channels.

In particular, it is possible to transmit, in the data stream carrying one or more programmes, information related to one or more application(s) intended to be executed by a receiver, in particular allowing the receiver to benefit from additional content.

Thus, the HbbTV (Hybrid Broadcast Broadband TV) or ATSC 3.0 standards, for example, allow to associate an application with a television programme. For this purpose, a data stream used to transport a television programme carries additional signalling information, allowing a receiver to reconstruct a URL type address and download an application located at a location identified by this URL.

The insertion of signalling information linked to an application is conventionally carried out at the head end. The stream is then transported and adapted according to the type of network used for broadcasting (terrestrial, satellite, . . . ).

The documents “Hybrid Broadcast Broadband TV”, ETSI TS 102 796 V1.4.1 (2016-08), and “ATSC Standard: Signalling, Delivery, Synchronisation, and Error Protection” Doc. A/331: 2019, Jun. 20, 2019, describe in particular the signalling to be inserted into the data stream so that the receivers can download and execute an application associated with a television programme.

As the application is associated with a television programme, it can be executed by all receivers receiving the television programme regardless of the network used for broadcasting the data stream.

It is noted for this purpose that certain television programmes can be broadcast on several broadcast networks. For example, the same programme can be broadcast via one or more satellite broadcast networks in different packages (according to the DVB-S2 standard for example), via one or more cable broadcast networks (according to the DVB-C standard for example), and/or via one or more terrestrial broadcast networks (according to the DVB-T2 standard for example).

If a programme is broadcast by several broadcast networks, a television operator may wish to know the network used for the broadcast of the programme seen by the viewer. For this purpose, it can carry out surveys or rely on audience measurement companies, such as Médiamétrie® in France.

A disadvantage of such a solution is that it does not allow to precisely measure the audience of a television programme for a particular broadcast network. In addition, it does not allow real-time measurement.

There is therefore a need for a new technique allowing, for example, television operators to measure the audience of a television programme, distributed by network used to broadcast the television programme.

### 3. DESCRIPTION OF THE INVENTION

The invention proposes, in at least one embodiment, a solution not having all the disadvantages of the prior art, in the form of a method for broadcasting a data stream in at least one broadcast network, comprising inserting, into the data stream, at least one identifier associated with at least one broadcast area of the broadcast network used to broadcast the data stream.

According to the invention, the identifier(s) are transmitted in signalling information of an application intended to be executed by at least one receiver of the data stream.

It is thus possible to transmit, in the data stream, one or more identifiers associated with one or more broadcast areas of the data stream. Thus, upon reception of the data stream, a receiver can connect to a service platform hosting the application identified in the signalling information, and transmit to the service platform the identifier(s) carried by the signalling information of the application.

The service platform can therefore collect information relating to the broadcast area(s) associated with an application (the same application can be associated with one or more programmes). If the application is associated with a single television programme, regardless of the network used to broadcast the programme, it is possible to measure the number of receivers receiving this programme per broadcast area. Thus, if the service platform is managed by the television operator, the proposed solution can be mastered from start to finish by the television operator.

For example, an identifier can be associated with all the broadcast areas of a network, i.e. with the broadcast network itself (for example an identifier for a broadcast via a satellite S1 over an entire country). An identifier can also be associated with a broadcast area of a network, for example with an SFN (“Single Frequency Network”) cell. It is also possible to provide several identifiers in the signalling information of an application, for example an identifier for the broadcast network and an identifier for the broadcast area.

Thus, the identifier(s) transmitted in the signalling information of an application allow in particular to measure the number of receivers receiving a data stream broadcast on a particular broadcast network, and/or in a particular broadcast area.

According to at least one embodiment, the proposed solution thus allows to measure the audience or the activity on one or more broadcast areas (for example an SFN cell), in real time.

It should also be noted that several identifiers can also be transmitted in the data stream, when the latter carries several television programmes.

According to a particular embodiment, when an identifier is associated with a broadcast area, the proposed solution allows the geolocation of a receiver at the granularity of a broadcast area, by identifying the broadcast area associated with the reception of the data stream by the receiver.

It is thus possible to broadcast in the identified broadcast area, content specific to the location of the receiver, such as an advertisement for example.

It is noted in particular that the proposed solution does not require any particular information from the viewer, since no attempt is made to precisely locate the receiver.

In addition, compared to the use of a public IP address of the receiver for the geolocation of the receiver, the proposed solution based on the insertion of an identifier associated with a broadcast area allows the geolocation of the receiver even when a private virtual network (“VPN”) is used by the receiver.

According to a particular embodiment, if signalling information of the application is present in the data stream prior to the insertion of at least one identifier, then the insertion of at least one identifier implements a modification of the signalling information.

Otherwise, the insertion implements an insertion of the signalling information into the data stream.

Thus, the insertion of the identifier(s) can be implemented at the head end or in another device of the network, located between the head end and the receivers.

In particular, if a splicing is implemented in the broadcast network, for example by replacing a national programme by a regional programme in the data stream, it is possible to insert an identifier in the signalling information of an application associated with the regional programme. It is thus possible to measure the number of receivers having received this regional programme.

According to a particular embodiment, default identifier(s) values can be provided in the signalling information, when it is created. Thus, the structure of the stream at the input of the inserter and at the output of the inserter is not modified. Only the default identifier value is overridden by the value configured in the inserter.

According to a first embodiment, said at least one identifier is transmitted in a table carrying information relating to the application. For example, if the application is an application according to the HbbTV standard, said at least one identifier (or at least part of the identifier) can be transmitted in the descriptor “transport_protocol_descriptor” and/or in the descriptor “simple_application_location_descriptor” of a table AIT (“Application Information Table”) associated with the application.

For example, an identifier of a broadcast area is transmitted in one of the two descriptors, and an identifier of a set of broadcast areas or of the broadcast network is transmitted in the other of the two descriptors.

According to a second embodiment, said at least one identifier is transmitted in an HTML entry page location descriptor. For example, if the application is an application according to the ATSC 3.0 standard, said at least one identifier (or at least part of the identifier) is transmitted in the “bbandEntryPageUrl” field of a HELD (“HTML Entry pages Location Description”) structure associated with the application.

Regardless of the embodiment, the identifier(s) can be inserted in the form of a parameter and/or a modification of the access path to the application.

In another embodiment, the invention relates to a corresponding broadcast device.

Such a broadcast device, also called an inserter, is in particular adapted to implement the broadcast method described above. It may of course include the different features relating to the broadcast method according to the invention, which can be combined or taken separately.

For example, such a device belongs to the group comprising:
if the context of the HbbTV standard is considered:
   a multiplexer, for example of the MPEG-TS type,
   a format conversion gateway, for example of the ASI/IP conversion type,
   a remultiplexer,
   a transcoder,
   a splicer equipment,
   etc,
if the context of the ATSC 3.0 standard is considered:
   an IP switch (“seamless IP switch”),
   a broadcast gateway,
   a signalling server
   etc.

The invention moreover relates, according to at least one embodiment, to a method for receiving a data stream broadcast in at least one broadcast network, implemented by a receiver, comprising transmitting, to a service platform, a request to download an application intended to be executed by said receiver, said request being built from at least one identifier associated with at least one broadcast area of the broadcast network used to broadcast the data stream, and said at least one identifier being transmitted in signalling information of the application carried by the data stream.

Such a reception method is in particular adapted to receive a data stream broadcast according to the reception method presented previously. It could of course include the various features relating to the broadcast method according to the invention, which can be combined or taken separately.

As indicated previously, upon reception of the data stream, and in particular signalling information of an application, the receiver can connect to a service platform hosting the application identified in the signalling information, and thus transmit to the platform the identifier(s) carried by the signalling information of the application.

In particular, the receiver builds a request for downloading the application from the signalling information of the application, and in particular from the identifier(s). Such a request is for example formed from a URL address.

According to a first example, the request identifies an access path specific to the application, built from said at least one identifier. For example, if the application is built according to the HbbTV standard, the request is built by concatenating the information carried by the descriptor “transport_protocol_descriptor” and the information carried by the descriptor “simple application location descriptor”, one and/or the other of these descriptors carrying said at least one identifier.

According to a second example, the request carries at least one parameter obtained from said at least one identifier. For example, if the application is built according to the HbbTV standard, the request is built by concatenating the information carried by the descriptor “transport_protocol_descriptor” and the information carried by the descriptor “simple_application_location_descriptor”, and using said at least one identifier as a parameter (i.e. variable) of the request.

In particular, the reception method implements:
the storage of said at least one identifier in a memory of the receiver,
when the application is executed by the receiver, the use of said at least one identifier in at least one communication request between the application and the service platform.

In this way, the receiver has the identifier and can provide it in any other request or new connection with the service platform hosting the application, or with another platform, according to a communication protocol. For example, this protocol can be of the http or WebSocket type.

According to a specific embodiment, the reception method also comprises:
obtaining at least one information associated with said receiver,
transmitting said at least one information associated with said receiver to said service platform.

For example, said at least one information associated with said receiver belongs to the group comprising:
an identifier of said receiver,
a list of television programmes received by said receiver,
a network identifier (ONID, “Original Network Identifier”),
a data stream identifier (TSID, “Transport Stream Identifier”),
a service identifier (SID),
etc.

It is thus possible to transmit to the service platform information associated with the receivers by area/broadcast network.

In another embodiment, the invention relates to a corresponding reception device.

Such a reception device, also called a receiver, is in particular adapted to implement the reception method described above. It could of course include the different features relating to the reception method according to the invention, which can be combined or taken separately.

In particular, such a receiver can be integrated into a television, in particular a television called “connected” television, or into a decoder of the “set-top box” type (Internet TV box, compatible TNT box, connected cable decoder, etc).

In particular, the proposed solution can be implemented by any terminal compatible with the ATSC 3.0 or HbbTV standards. It therefore does not require any particular resources at the receiver.

The invention also relates, according to at least one embodiment, to a method for analysing a data stream broadcast in at least one broadcast network, implemented by a service platform, comprising:
receiving, from at least one receiver of said data stream, a request to download an application intended to be executed by said at least one receiver, said request being built from at least one identifier associated with at least one broadcast area of the broadcast network used to broadcast said data stream, said at least one identifier being transmitted in signalling information of said application carried by said data stream, and
extracting, from said request, said at least one identifier.

It is thus possible to collect, at the service platform, the identifier(s) broadcast in a data stream received by a receiver, i.e. associated with an application intended to be executed by a receiver.

In particular, the analysis method comprises determining, from said at least one identifier, the number of receivers receiving said data stream in the broadcast area(s) associated with said at least one identifier.

In this way, it is possible to measure the audience on a broadcast area, or on a broadcast network. The television operator can thus adapt the broadcasting of programmes by taking account of the audience, or know the audience provided by a network and justify the cost of broadcasting in a broadcast area.

According to another example, obtaining the identifier(s) allows the service platform to locate a receiver according to the identifier. It is thus possible to provide the receiver with content specific to its location.

According to a particular embodiment, the analysis method also comprises receiving at least one information associated with said receiver.

It is thus possible to collect, at the service platform, information associated with the receivers per broadcast area (or sets of broadcast areas).

In another embodiment, the invention relates to a corresponding analysis device.

Such a device, also called a service platform, is in particular adapted to implement the above analysis method. It could of course include the different features relating to the analysis method according to the invention, which can be combined or taken separately.

In particular, the broadcast, reception and analysis methods according to at least one embodiment of the invention can be implemented in various ways, in particular in hardware form and/or in software form.

For example, at least one step of the broadcast, reception and/or analysis methods can be implemented:
on a reprogrammable calculation machine (a computer, a processor for example DSP (“Digital Signal Processor”), a microcontroller, etc) executing a program comprising a sequence of instructions,
on a dedicated calculation machine (for example a set of logic gates such as an FPGA (“Field Programmable Gate Array”) or an ASIC (“Application-Specific Integrated Circuit”), or any other hardware module).

Consequently, an embodiment of the invention also aims at protecting one or more computer programs including instructions adapted to the implementation of the broadcast, reception and analysis methods as described above when this or these programs are executed by a processor, as well as at least one computer-readable storage medium including instructions of at least one computer program as mentioned above.

### 4. LIST OF FIGURES

Other features and advantages of the invention will appear more clearly upon reading the following description of a particular embodiment, given by way of a simple illustrative and non-limiting example, and the appended drawings, among which:

FIG. 1 shows an example of a system wherein the invention can be implemented;

FIG. 2 illustrates the main steps implemented by the different methods according to one embodiment of the invention;

FIG. 3 is a flowchart illustrating the configuration of an inserter according to one embodiment of the invention;

FIG. 4 shows an example of implementation of a service platform according to an embodiment of the invention;

FIG. 5

FIG. 6 FIGS. 5 and 6 show two examples of implementation of the invention for broadcasting a service via several broadcast networks;

FIG. 7

FIG. 8

FIG. 9 FIGS. 7 to 9 respectively illustrate the simplified structure of an inserter, a receiver, and a broadcast gateway according to one embodiment of the invention.

### 5. DESCRIPTION OF EMBODIMENTS OF THE INVENTION

### 5.1 General Principle

The general principle of the invention is based on the insertion, in the signalling information of an application transmitted in a data stream between an emitter (for example a head end) and at least one receiver (for example a connected television), of at least one identifier allowing to uniquely identify at least one geographical broadcast area of the network used to broadcast the data stream.

In this way, when the receiver launches a request to download or run the application on an address obtained from the signalling information of the application, a service platform hosting the application (or communicating with a server hosting the application) can identify the broadcast area(s) of the network corresponding to the data stream actually received by the receiver, and therefore geolocate the broadcast, in particular if several broadcast areas overlap at least partially.

In particular, such an application can be associated with a programme transported by the data stream (television programme or radio programme, for example). Thus, according to at least one embodiment, the proposed solution allows to measure the audience, by broadcast area (or broadcast network, if a broadcast area associated with a country for example, or several broadcast areas covering a country is considered), of a television programme broadcast using technologies of the ATSC 3.0, DVB-T, DVB-T2, DVB-S, DVB-S2 or DVB-C type, for example. Audience measurement can be done by broadcast area using technologies of the DVB-T, DVB-T2, or ATSC 3.0 type for example.

According to another example, such an application can adapt the content that it restitutes taking account of the broadcast area identifier (advertisements or information adapted to the geographical broadcast area, for example).

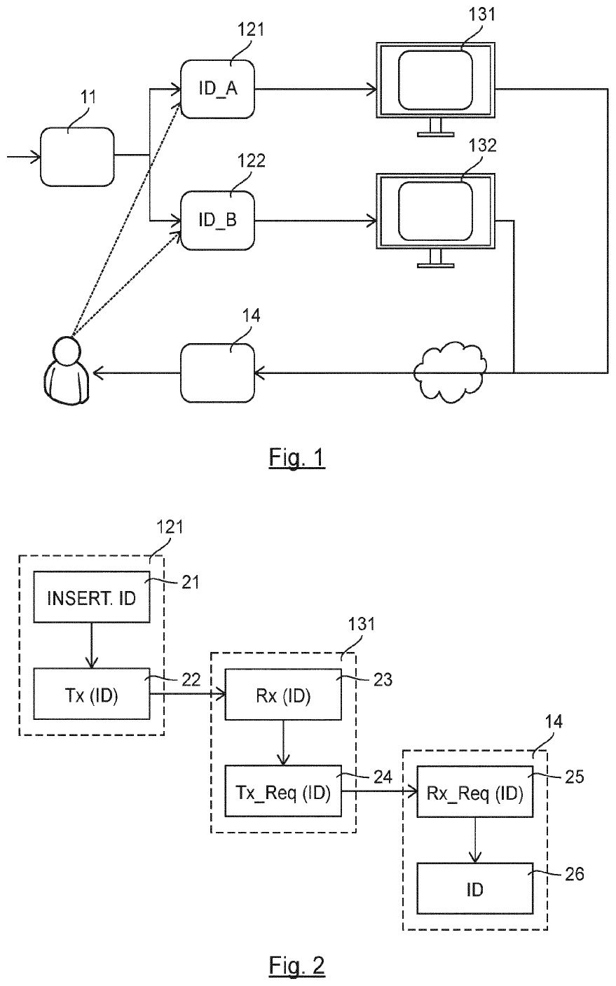

An example of a system wherein the invention can be implemented is presented in relation to FIG. 1. Such a system comprises:
a head end 11,
at least one inserter, for example two inserters 121 and 122, each allowing to receive the signal distributed by the head end, to shape the data stream by inserting a distinct identifier therein, and to broadcast the data stream carrying an identifier,
at least one receiver, for example two receivers 131 and 132, each allowing to receive the data stream carrying an identifier, and to connect to an application identified from the data stream, and
a service platform 14, hosting the application or connected to a server hosting the application.

The inserter(s) (121, 122) each belong to a distinct broadcast area, and are used to adapt the signalling information to the broadcast area wherein the broadcast is to be measured.

If the context of television programme broadcasting is considered, an inserter can thus introduce or modify, in the data stream, the signalling of an HbbTV or ATSC 3.0 application, for each broadcast area to be measured.

According to at least one embodiment of the invention, this signalling allows:
to download and/or execute an application on the compatible receivers and receiving the data stream,
to uniquely identify the broadcast areas to be measured.

This identification must be accessible by the application and/or by the service platform, in order to be able to measure the number of receivers downloading and/or executing the application.

It should be noted in this regard that the modulation information is not available in HbbTV or ATSC 3.0.

Advantageously, one instance of the insertion device is provided per broadcast area that is to be identified. If it is desired to identify the broadcast network, one instance of the insertion device can be provided per broadcast network (satellite, cable, terrestrial).

The receiver(s) (131, 132) are for example compatible with the HbbTV or ATSC 3.0 standards, and allow to collect information on the receiver, in particular on the programme received.

A receiver can thus obtain, from the signalling information carried by the broadcast data stream, the address of the application identified by the signalling information, for example a URL address, and make a request to download the HbbTV or ATSC 3.0 application referenced by the URL. In particular, such a request is built taking account of the identifier transmitted in the signalling information of the application. The proposed solution thus allows to modify a URL present in the broadcast data stream to identify a geographical broadcast area.

Such a receiver can also execute the application referenced by the URL, or another application, to collect data associated with the receiver, such as an identifier of the receiver, the list of programmes received (i.e. restituted), etc.

These data, and in particular the identifier associated with at least one broadcast area, can be used by the service platform 14 to determine the location of the receiver.

In particular, the identifier(s) are kept in a memory of the receiver and accessible by the application executed on the receiver. This allows the receiver to provide this information again in all requests or new connection opened and maintained with the service platform. For example, these requests can be of the http or WebSocket type.

The service platform (14) is used to perform measurements and optionally analyse audience data.

Therefore, it receives download requests from the receivers, and optionally data associated with the receivers.

Thus, according to at least one embodiment, the proposed solution allows to measure the audience associated with one programme by broadcast area (SFN cell for example) and/or by broadcast network (by satellite, by cable, etc). It is particularly relevant for estimating the eligible base, i.e. the number of receivers compatible with applications according to the HbbTV or ATSC 3.0 standard for example, and/or measuring the addressable base for performing local splicing in a broadcast network.

### 5.2 Examples of Implementation of Broadcast, Reception and Analysis Methods

The main steps implemented for broadcasting, receiving and analysing a data stream according to one embodiment of the invention are presented below in relation to FIG. 2.

As illustrated in FIG. 2, an insertion device, for example the inserter 121 or the inserter 122, implements the insertion (21), into the data stream, of at least one identifier associated with at least one broadcast area of the broadcast network used to broadcast the data stream (ID_A for the inserter 121 and ID_B for the inserter 122, for example).

After insertion of the identifier(s) associated with at least one broadcast area, the insertion device broadcasts (22) the data stream in the broadcast network, to at least one receiver.

For example, if the insertion device is integrated into the head end 11, it takes the programmes to be broadcast as input, and outputs a data stream comprising in particular signalling information of an application intended to be executed by at least one receiver of the data stream, carrying the identifier(s) of the area or of the broadcast network. If the insertion device is downstream of the head end (inserter 121 for example), it takes as input a signal distributed by the head end 11, or a data stream with “classic” signalling information of the application, and outputs a modified data stream with signalling information carrying the identifier(s) of the broadcast area, as configured in the insertion device.

The role of the insertion device is therefore to insert, in the streams broadcast, at least one different identifier for each broadcast area (for example an SFN cell), or each set of broadcast areas (for example all the broadcast areas associated with the broadcast network), for which a measurement is to be performed.

As indicated previously, the identifier(s) are transmitted in the signalling information of an application.

According to a particular embodiment, such an application being associated with a television programme, the identifier(s) are added to the URL used to download the application associated with the television programme.

According to a first example, such a URL is carried by a table carrying information relating to said application, such as the table AIT according to the HbbTV standard.

More specifically, the URL is carried by the descriptors “transport_protocol_descriptor” and “simple_application_location_descriptor” according to the HbbTV standard. One and/or the other of these descriptors can thus be modified to add the identifier(s) therein.

According to a second example, such a URL is carried by an HTML entry page location descriptor, such as the HELD descriptor according to the ATSC 3.0 standard.

More specifically, the URL is carried by the “bbandEntryPageUrl” field of the HELD structure according to the ATSC 3.0 standard. Such a field can thus be modified to add the identifier(s) therein, in the form of a parameter and/or modification of the access path.

Regardless of the embodiment considered, the identifier(s) can be inserted into the URL by modifying the access path to the application and/or by adding a parameter to the URL. A first identifier can in particular be inserted by modifying the access path to the application and a second identifier in the form of a parameter.

For example, if the signalling information of the application “monapp”, at the input of the insertion device, is:

monsite.com in the descriptor “transport protocol descriptor” and monapp.html in the descriptor “simple_application_location_descriptor”, then, at the output of the insertion device, they can be:

monsite.com/ID in the descriptor “transport_protocol_descriptor” and monapp.html in the descriptor “simple_application_location_descriptor”, or monsite.com/ in the descriptor “transport_protocol_descriptor” and ID/monapp.html in the descriptor “simple_application_location_descriptor”, with ID the identifier of the broadcast area (for example ID=ID_A for the inserter 121 and ID=ID_B for the inserter 122).

According to another example, if the signalling information of the application “monapp”, at the input of the insertion device, is:

monsite.com in the descriptor “transport_protocol_descriptor” and monapp.html in the descriptor “simple_application_location_descriptor”, then, at the output of the insertion device, they can be:

monsite.com in the descriptor “transport_protocol_descriptor” and monapp.html?id=ID in the descriptor “simple_application_location_descriptor”.

When the identifier is passed as a parameter, the insertion device can add the identifier as an additional parameter or replace one or more existing parameters. The mode of operation can be selected in the configuration of the insertion device.

According to at least one embodiment, the insertion device is configurable. It takes as input the identifier to be inserted, the insertion method to be used (for example modification of the access path and/or parameter) and the identification of the programme to be modified (i.e. signalling information of the application associated with a programme for which the audience is to be measured for example). Note that this configuration allows to modify signalling already existing in the data stream.

In the case of creating and inserting signalling, a complete configuration can be implemented to create the signalling.

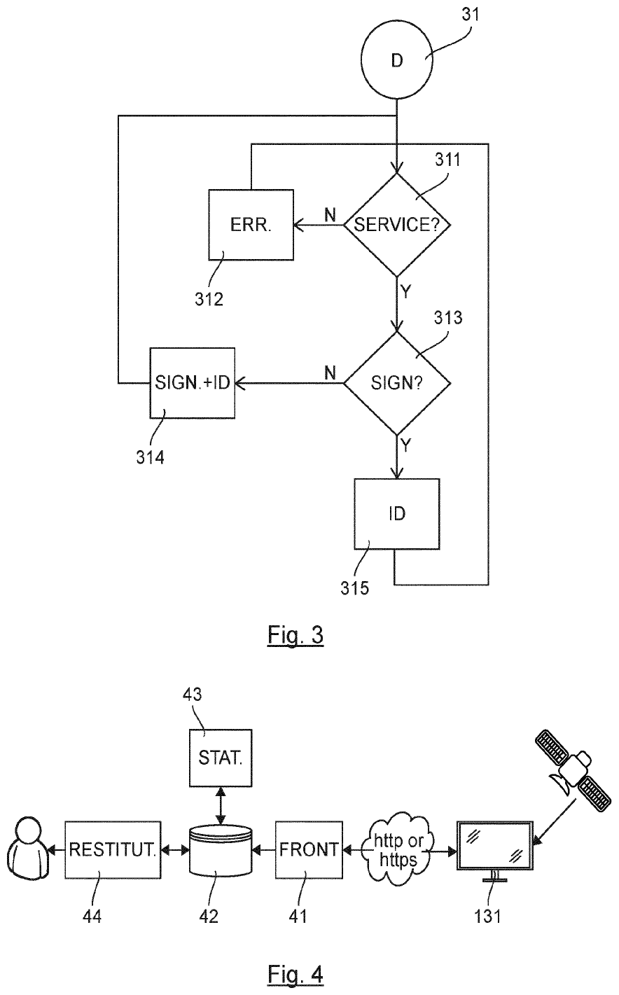

For example, as illustrated in FIG. 3, when the insertion device is started 31, the latter checks 311 whether the service is present, i.e. whether it is possible to identify at least one broadcast area in the data stream.

If the service is not present, an error is notified (312).

If the service is present, the inserter checks whether “classic” signalling information of the application is present in the stream (313).

If the “classic” signalling information is not present, the insertion device creates and inserts the signalling information of the application, with the identifier(s) (314).

If the “classic” signalling information is present, the insertion device modifies the signalling information to insert the identifier(s) (315) therein.

As indicated above, such an insertion device can be integrated into a head end, or located in the broadcast network, upstream of the receivers. It can be dedicated equipment in the broadcast network, or a software component integrated into existing equipment.

In particular, it can be integrated into any equipment processing MPEG-TS/MPEG2-TS or ATSC3 type transport streams.

Returning to FIG. 2, a receiver therefore receives (23) a data stream, with signalling information of an application carrying at least one identifier of a broadcast area (for example the receiver 131 for the broadcast network to which the inserter 121 belongs, or the receiver 132 for the broadcast network to which the inserter 122 belongs).

From this signalling information, the receiver builds a request for downloading the corresponding application, carrying the identifier(s), and transmits (24) this request to a service platform, for example the service platform 14.

According to one embodiment, the inserted signalling allows the receiver to download an application. The receiver therefore comprises a module allowing to interpret the signalling information of the application contained in the data stream, for example a URL address, and to build the download request, for example an http or WebSocket request, to download the application referenced by URL. It is noted that such a signalling interpretation module is present in receivers compatible with the HbbTV and ATSC 3.0 standards.

If the identifier(s) are inserted into the URL by modifying the access path to the application, and if the context of the HbbTV standard is considered, the content of the two descriptors “transport_protocol_descriptor” and “simple_application_location_descriptor” can be concatenated to form the request http://monsite.com/ID/monapp.html. If the context of the ATSC 3.0 standard is considered, the contents of the “bbandEntryPageUrl” field of the HELD structure can be extracted to form the request http://monsite.com/ID/monapp.html.

If the identifier(s) are inserted by adding a parameter in the URL and if the context of the HbbTV standard is considered, the content of the two descriptors “transport_protocol_descriptor” and “simple_application_location_descriptor” can be extracted to form the request http://monsite.com/monapp.html?id=ID. If the context of the ATSC 3.0 standard is considered, the contents of the “bbandEntryPageUrl” field of the HELD structure can be extracted to form the request http://monsite.com/monapp.html?id=ID.

It should also be noted that the application referenced by the URL may contain an SDK (“Software Development Kit”), which can be used to collect data associated with the receiver and send them to the service platform. Alternatively, another application can be downloaded and launched by the receiver when it restitutes the programme to collect data associated with the receiver and send it to the service platform. One or the other of these applications collects, for example, at least one element belonging to the group comprising: the unique identifier of the receiver, the list of channels received by the receiver, the DVB triplet for each channel in the list for the HbbTV receivers, etc.

Note that if the identifier(s) are passed as a parameter in the URL, one or the other of these applications can also collect this parameter.

According to a particular embodiment, these applications are written in compliance with the A344 specifications of the ATSC 3.0 standard or the HbbTV standard.

Returning to FIG. 2, the service platform thus receives (25), from the receiver 131 and/or the receiver 132, and optionally other receivers, a request to download an application intended to be executed by the corresponding receiver.

The service platform can extract (26) the identifier(s) carried by the request(s) received, as well as possibly other data from the receivers.

Thus, if the application is linked to a television programme, the reception on a receiver of the television programme (i.e. its restitution) allows to inform the service platform of the broadcast area and/or of the broadcast network used for broadcasting the data stream received by the receiver.

The service platform can thus determine the audience and/or the number of receivers for each broadcast area and/or each broadcast network.

An example of implementation of the service platform 14 is described below in relation to FIG. 4. According to this example, the platform comprises a set of modules allowing the collection of data, their processing and the restitution of the results of the processing operations.

Thus, a front module 41 receives requests for downloading applications from receivers, for example of the HTTP, HTTPS, FTP type, or the like. It extracts the identifier(s) from the request (for example from the URL received in the request) and stores them in a database 42.

In particular, the front module 41 is capable of extracting the identifier(s) from the request if it is aware of the configuration used by the insertion device to insert the identifier(s) into the signalling information of the application.

For example, the front module 41 knows the position and/or the structure of the identifier(s) inserted by the insertion device into the signalling information of the application.

Thus, the front module 41 can extract the identifier(s) of the request if they are passed as parameters and/or in the access path to the application.

Any data associated with the receiver emitting the download request (carried by the request or received in another message) can be recorded in the database 42, in relation to the identifier(s). For example, this data can be the time of reception of the download request, or as already indicated, the list of channels received by the receiver, a unique identifier associated with the receiver, etc.

The database 42 (possibly several databases) can store the data coming from the receivers, as well as possibly the results of statistical calculations.

Thus, according to at least one embodiment, the database 42 carries a table of correspondence between the identifiers and the description of the associated broadcast area(s) (identification of the receivers, list of channels received per receiver, etc).

A statistical analysis module 43 can also be provided. This module can use the data stored by the front module 41 in the database 42 to calculate statistics per identifier.

The result of the calculations can be stored in the database 42 or in a separate base to allow their later restitution.

In particular, such a statistical analysis module 43 can calculate the number of receivers or the audience per broadcast area (at an SFN cell, a network, . . . ), per channel.

It is also noted that the receivers can be localised to within the broadcast area. This localisation can be improved by using the list of channels received by the receiver. For example, a receiver receiving a service via a satellite broadcast and a terrestrial broadcast can be located using the list of channels received via the terrestrial broadcast.

Finally, a restitution module 44 can also be provided to restitute the statistics calculated per broadcast area (network or SFN cell for example), for example in the form of files or via a website.

### 5.3 Examples of Systems Broadcasting a Service Via Several Broadcast Networks

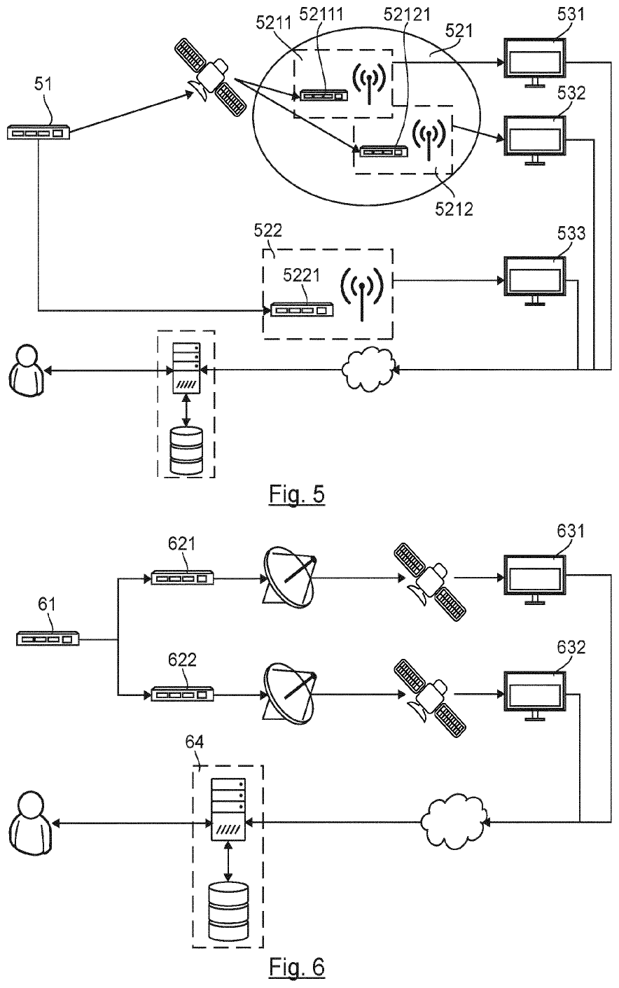

Described below, in relation to FIGS. 5 and 6, are two examples of implementations of the invention for broadcasting a service via several broadcast networks.

According to the example illustrated in FIG. 5, the broadcasting of the same service is considered, for example a television programme, via two terrestrial broadcast networks of the DVB-T, T2 or ATSC 3.0 type: an SFN network and an MFN network.

According to the invention, it is sought to identify whether the service received by the receivers 531, 532, 533 has been broadcast in the SFN network or in the MFN network.

The SFN network comprises an SFN cell 521, comprising two broadcast sites 5211 and 5212, each emitting a data stream at the same frequency. Each broadcast site receives a signal distributed by a head end 51, shapes it, and broadcasts a data stream.

For example, a first inserter 52111 is provided in the broadcast site 5211, and a second inserter 52121 in the broadcast site 5212. Such inserters each implement the insertion 21 and broadcast 22 steps described in relation to FIG. 2, to insert an identifier ID_A in the signalling of an application associated with the service in the data stream. The insertion or modification of the signalling can thus be carried out in a deterministic manner at the bottom of each emitter of the broadcast sites 5211 and 5212. For example, the inserter is integrated into equipment conventionally used to carry out a local splicing.

Alternatively, a single inserter is provided for all the broadcast sites of an SFN cell.

According to the example illustrated, a unique identifier ID_A is provided for the various emitters of an SFN cell.

The MFN network comprises a broadcast site 522. The broadcast site 522 receives the signal distributed by the head end 51, shapes it, and broadcasts a data stream.

The broadcast site 522 comprises an inserter 5221 implementing the insertion 21 and broadcast 22 steps described in relation to FIG. 2, to insert an identifier ID_B into the signalling of the application associated with the service in the data stream. The insertion or modification of the signalling can be carried out by a gateway before broadcasting.

The receiver 531 receives the service from the broadcast site 5211 of the SFN cell 521, in a data stream carrying the identifier ID_A, the receiver 532 receives the same service from the broadcast site 5212 of the SFN cell 521, in a data stream carrying the identifier ID_A, and the receiver 533 receives the same service from the broadcast site 522 of the MFN network, in a data stream carrying the identifier ID_B.

When the receivers 531 to 533 receive the data stream, they activate the service (restitute the television programme for example) and each transmit to the service platform 54 a download request built from the identifier carried in the data stream, as described in connection with steps 23 and 24 in FIG. 2.

The service platform 54 can extract the identifiers carried by the download requests that it receives, as described in relation to steps 25 and 26 of FIG. 2, and measure, for each network, the number of receivers having received the service: the receivers 531 and 532 for the SFN network identified by the identifier ID_A, and the receiver 533 for the MFN network identified by the identifier ID_B.

According to the example illustrated in FIG. 6, the broadcasting of a same service is also considered, but via two satellite broadcast networks (same television programme broadcast in two satellite packages for example).

According to the invention, it is sought to identify whether the service received by the receivers 631, 632 has been broadcast in the first satellite broadcast network or in the second satellite broadcast network.

The first network comprises an inserter 621 receiving a signal distributed by a head end 61 and delivering a data stream intended to be broadcast by a satellite in a broadcast area corresponding for example to a country A. The inserter 621 implements the insertion 21 and broadcast 22 steps described in relation to FIG. 2, to insert an identifier ID_A in the signalling of an application associated with the service in the data stream.

In the same way, the second satellite network comprises an inserter 622 receiving the signal distributed by the head end 61 and delivering a data stream intended to be broadcast by a satellite in a broadcast area corresponding for example to a country B. The inserter 622 implements the insertion 21 and broadcast 22 steps described in relation to FIG. 2, to insert an identifier ID_B into the signalling of the application associated with the service in the data stream.

For example, the insertion or modification of the signalling can be carried out in the multiplexers/re-multiplexers used to create the various packages.

The receiver 631 receives the service from the first satellite network, in a data stream carrying the identifier ID_A, and the receiver 632 receives the same service from the second satellite network, in a data stream carrying the identifier ID_B.

When the receivers 631 and 632 receive the data stream, they activate the service (restitute the television programme for example) and each transmit to the service platform 64 a download request built from the identifier carried in the data stream, as described in connection with steps 23 and 24 of FIG. 2.

The service platform 64 can extract the identifiers carried by the download requests that it receives, as described in relation to steps 25 and 26 of FIG. 2, and measure, for each network, the number of receivers having received the service: the receiver 631 for the first network identified by the identifier ID_A, and the receiver 632 for the second network identified by the identifier ID_B.

### Variants

Two examples of implementation of the invention have been described above for broadcasting a service via two distinct broadcast networks. Of course, the invention can be implemented regardless of the number of broadcast networks used for broadcasting.

Similarly, the invention can be implemented when a single network is used for broadcasting the stream, in particular when the network implements several emitters each associated with a distinct broadcast area.

As indicated above, it is also possible to insert several identifiers in the signalling information of an application carried by a data stream, for example an identifier associated with the broadcast network or the operator of the broadcast network, and an identifier associated with a broadcast area.

According to a particular embodiment, it is also possible to produce all the necessary signalling versions at the head end, to transport them all and to choose the signalling to be used just before broadcasting. This embodiment is of interest, for example, when a re-multiplexing function is provided before broadcasting.

Finally, the invention is not limited to applications according to the HbbTV or ATSC 3.0 standards.

### Corresponding Devices

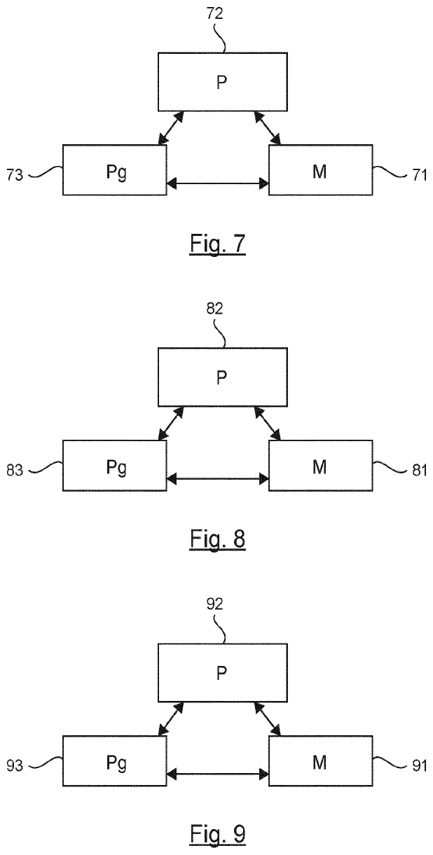

Finally, in relation to FIGS. 7 to 9, the simplified structures of an inserter, of a receiver and of a service gateway are presented according to one embodiment of the invention.

As illustrated in FIG. 7, an inserter comprises a memory 71 (comprising for example a buffer memory) and a processing unit 72 (equipped for example with at least one processor, FPGA, or DSP), controlled or pre-programmed by an application or a computer program 73 implementing the insertion method according to one embodiment of the invention.

Upon initialisation, the code instructions of the computer program 73 are for example loaded into a RAM memory before being executed by the processing unit 72. The processing unit 72 implements the steps of the insertion method described previously, according to the instructions of the computer program 73. For this purpose, according to one embodiment, the processing unit 72 is configured to insert, into the data stream, at least one identifier associated with at least one broadcast area of the broadcast network used to broadcast said data stream, said at least one identifier being transmitted in signalling information of an application intended to be executed by at least one receiver of said data stream.

As illustrated in FIG. 8, a corresponding receiver comprises a memory 81 (comprising for example a buffer memory) and a processing unit 82 (equipped for example with at least one processor, FPGA, or DSP), controlled or pre-programmed by an application or a computer program 83 implementing the reception method according to one embodiment of the invention.

Upon initialisation, the code instructions of the computer program 83 are for example loaded into a RAM memory before being executed by the processing unit 82. The processing unit 82 implements the steps of the reception method described previously, according to the instructions of the computer program 83. For this purpose, according to one embodiment, the processing unit 82 is configured to transmit, to a service platform, a request to download an application intended to be executed by said receiver, said request being built from at least one identifier associated with at least one broadcast area of the broadcast network used to broadcast said data stream, and said at least one identifier being transmitted in signalling information of said application carried by said data stream.

As illustrated in FIG. 9, a service platform comprises a memory 91 (comprising for example a buffer memory) and a processing unit 92 (equipped for example with at least one processor, FPGA, or DSP), controlled or pre-programmed by an application or a computer program 93 implementing the analysis method according to one embodiment of the invention.

Upon initialisation, the code instructions of the computer program 93 are for example loaded into a RAM memory before being executed by the processing unit 92. The processing unit 92 implements the steps of the analysis method described above, according to the instructions of the computer program 93. For this purpose, according to one embodiment, the processing unit 92 is configured to:
receive, from at least one receiver of said data stream, a request to download an application intended to be executed by said receiver, said request being built from at least one identifier associated with at least one broadcast area of the broadcast network used to broadcast said data stream, said at least one identifier being transmitted in signalling information of said application carried by said data stream,
extract, from said request, said at least one identifier.

1. A method for broadcasting a data stream in at least one broadcast network,
the method being implemented by a broadcasting device and comprising:
inserting, into said data stream, at least one identifier uniquely identifying at least one broadcast area of the broadcast network used to broadcast said data stream; and
transmitting said at least one identifier in signalling information of an application intended to be executed by at least one receiver of said data stream.

2. The method according to claim 1, wherein said application is associated with a television program.

3. The method according to claim 1, wherein if signalling information of said application is present in said data stream prior to said insertion of at least one identifier, then said insertion of at least one identifier implements a modification of said signalling information, otherwise, said insertion implements an insertion of said signalling information into said data stream.

4. The method according to claim 1, wherein said at least one identifier is transmitted in a table carrying information relating to said application.

5. The method according to claim 4, wherein said application is an application according to the HbbTV (Hybrid Broadcast Broadband Television) standard, and said at least one identifier is transmitted in a descriptor “transport_protocol_descriptor” and/or in a descriptor “simple_application_location_descriptor” of a table AIT (Application Information Table) associated with said application.

6. The method according to claim 1, wherein said at least one identifier is transmitted in an HTML (HyperText Markup Language) entry pages location descriptor.

7. The method according to claim 6, wherein said application is an application according to the Advanced Television Systems Committee (ATSC) 3.0 standard, and said at least one identifier is transmitted in the “bbandEntryPageUrl” field of an “HTML Entry pages Location Description” associated with said application.

8. A method for receiving a data stream broadcast in at least one broadcast network, implemented by a receiver, wherein the method comprises:
transmitting, to a service platform, a request to download an application intended to be executed by said receiver, said request being built from at least one identifier uniquely identifying at least one broadcast area of the broadcast network used to broadcast said data stream, and said at least one identifier being transmitted in signalling information of said application carried by said data stream.

9. The method according to claim 8, wherein said request identifies an access path specific to said application, built from said at least one identifier.

10. The method according to any claim 8, wherein said request carries at least one parameter obtained from said at least one identifier.

11. The method according to claim 8, further comprising:
storing said at least one identifier in a memory of said receiver, and
in response to said application being executed by said receiver, using said at least one identifier in at least one communication request between said application and said service platform.

12. A method for analysing a data stream broadcast in at least one broadcast network, implemented by a service platform, wherein the method comprises:
receiving, from at least one receiver of said data stream, a request to download an application intended to be executed by said at least one receiver, said request being built from at least one identifier uniquely identifying at least one broadcast area of the broadcast network used to broadcast said data stream, said at least one identifier being transmitted in signalling information of said application carried by said data stream, and
extracting, from said request, said at least one identifier.

13. The method according to claim 12, further comprising determining, from said at least one identifier, a number of receivers receiving said data stream in the at least one broadcast area identified by said at least one identifier.

14. A device for broadcasting a data stream in at least one broadcast network, wherein the device comprises:
at least one processor configured to:
insert, into said data stream, at least one identifier uniquely identifying at least one broadcast area of the broadcast network used to broadcast said data stream, and
transmit said at least one identifier in signalling information of an application intended to be executed by at least one receiver of said data stream.

15. (canceled)

16. (canceled)

17. (canceled)
